(19) United States
(12) Patent Application Publication
(10) Pub. No.: US 2007/0069944 A1
(43) Pub. Date: Mar. 29, 2007

(54) Simulated radar system and methods

(76) Inventor: Robert K. Buell, Ball Ground, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/238,368

(22) Filed: Sep. 29, 2005

(51) Int. Cl. G01S 13/93

(52) U.S. Cl. 342/169; 434/2; 342/182; 342/29

(57) ABSTRACT

An airborne radar display is simulated using electronic messages obtained from a traffic alert and collision avoidance system (TCAS). The system does not utilize radar. Rather, the data that is received by a TCAS receiver, such as the range and bearing of other aircraft in the vicinity, are transformed into a display resembling that of a conventional airborne radar system.

### FIELD OF THE INVENTION

The present invention relates generally to the field of aircraft radar systems and, more specifically, to simulated radar systems and methods for use in training pilots and/or radar operators in aircraft not equipped with a conventional radar system.

### BACKGROUND OF THE INVENTION

Today, many military aircraft employ on-board air-to-air and air-to-ground radar systems to provide their pilots with information, respectively, associated with other aircraft in flight and with features of the terrain being flown over. The air-to-air radar systems generally employ a tactical symbology to provide pilots with the range, bearing, and relative altitude of other aircraft on a radar display mounted in the cockpit. In addition, the air-to-air radar systems provide pilots with an indication of whether the other aircraft comprise enemy or non-enemy aircraft. The air-to-ground radar systems typically provide pilots with information related to terrain features being flown over. Such information includes the range, bearing, and altitude of various terrain features and different symbols associated with different types of terrain features.

The air-to-air and air-to-ground radar systems on an aircraft generally consume substantial physical space inside the cockpit of the aircraft for electronic components and utilize one or more antennae that are mounted in the aircraft's nose behind a protective nose cone. On many aircraft, the consumption of space for such radar systems is not an issue. However, on many aircraft used for training, physical space is at a premium and there is often not enough available space for such radar systems. As a consequence, many training aircraft are not fitted with such radar systems, thereby making it difficult for pilots in training to receive a substantial amount of flight time in aircraft equipped with such radar systems. Further, air-to-air and air-to-ground radar systems are generally costly and it is fiscally unfeasible to equip every training aircraft with such radar systems, even if sufficient physical space is available. Therefore, in order to receive sufficient training in the use of such radar systems, pilots in training must spend substantial time in expensive ground-based aircraft simulators having simulated air-to-air and air-to-ground radar systems.

Fortunately, however, many training aircraft are equipped with a Traffic Alert and Collision Avoidance System (“TCAS”) that provides pilots with visible and audible alerts and other information related to nearby aircraft that may pose a threat for a mid-air collision. FIG. 1 is a generalized block diagram representation of a conventional TCAS as known in the prior art. The TCAS generally comprises a controller that is connected to omni-directional and directional antennae in order to collect data corresponding to the range and bearing of such other aircraft. The TCAS controller is also connected to one or more control(s) that enable a pilot to select a range for the display of data related to aircraft features within such range. The TCAS controller is additionally connected to a display for the display of such data. Generally, during operation, the TCAS controller generates a TCAS display message for each nearby aircraft, including its range and bearing, that is communicated to the display via a communication link between the TCAS controller and display. Using the data present in the TCAS display message, the display presents an image using symbols to display such aircraft to pilots.

While TCAS provides pilots with information related to other aircraft that is similar to that provided by on-board air-to-air radar systems and enables pilots in training to become somewhat familiar with viewing displays containing information related to other aircraft, TCAS does not provide the tactical and other information provided to pilots by a typical military air-to-air or radar system. Thus, unfortunately, TCAS cannot supplant on-board military radar systems in military aircraft and cannot be employed alone in training aircraft to train military pilots in the use of military radar systems.

Therefore, there exists in the industry, a need for a relatively inexpensive simulated radar system having air-to-air and air-to-ground capabilities that addresses these and other problems or difficulties that exist now or in the future.

### SUMMARY OF THE INVENTION

The present invention relates to simulating airborne radar using electronic messages obtained from a traffic alert and collision avoidance system (TCAS). The invention simulates the display of a conventional air-to-air or, alternatively or in addition, air-to-ground airborne radar system but does not utilize radar. Rather, the data that is received by a TCAS receiver in the conventional manner, such as the range and bearing of other aircraft in the vicinity, are transformed into a display resembling that of a conventional airborne radar system. For example, in an-air-to-air embodiment, data representing such other aircraft can be displayed using the tactical military symbology that is standard in military airborne radar instead of using TCAS symbology. In an air-to-ground embodiment, a representation of the terrain over which the aircraft is flying can be displayed. Embodiments of the invention can include both an air-to-air mode and an air-to-ground mode, with the mode selectable by the pilot or other user. A terrain map can be stored in a suitable digital storage device integrated with the simulated radar system. The invention can be used, for example, to train student pilots in the use of radar in training aircraft that do not have radar. Other advantages and benefits of the present invention will become apparent upon reading and understanding the present specification when taken in conjunction with the appended drawings.

### BRIEF DESCRIPTION OF THE DRAWINGS

FIG. 1 is a block diagram representation of an aircraft traffic alert and collision avoidance system (TCAS) in accordance with the prior art.

FIG. 2 is a block diagram representation of a simulated radar system in accordance with an exemplary embodiment of the present invention.

FIGS. 3A-3C are flowchart representations, in accordance with the exemplary embodiment of the present invention, of a method for providing simulated air-to-air and air-to-ground radar for training pilots and/or radar operators.

FIG. 4 is a flowchart representation of a target data generation method, in accordance with the exemplary embodiment of the present invention, for producing and storing target data associated with aircraft detected by an aircraft traffic alert and collision avoidance system.

FIG. 5 is a flowchart representation of a target display data generation method, in accordance with the exemplary embodiment of the present invention, for generating target display data associated with aircraft detected an aircraft traffic alert and collision avoidance system.

FIG. 6 is a flowchart representation of a terrain display data generation method, in accordance with the exemplary embodiment of the present invention, for generating terrain display data associated with overflown or nearby terrain.

### DETAILED DESCRIPTION

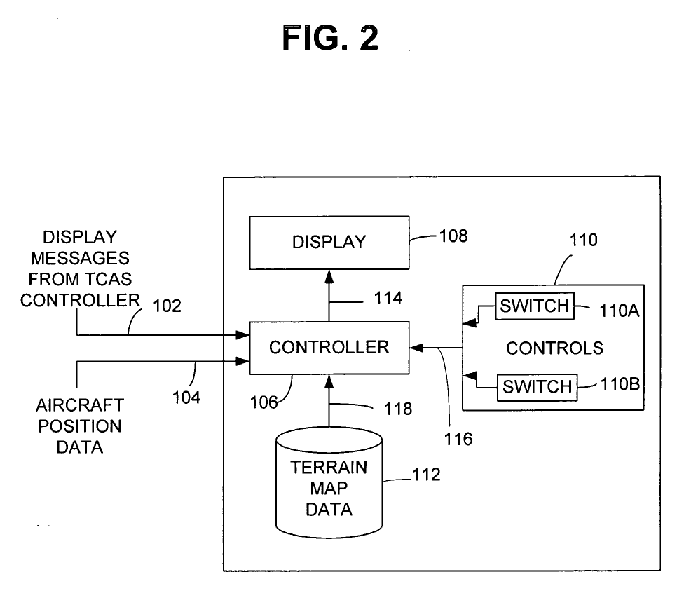

Referring now to the drawings in which like numerals represent like elements or steps throughout the several views, FIG. 2 is a block diagram representation of a simulated radar system 100 in accordance with an exemplary embodiment of the present invention. The simulated radar system 100 generally resides within an aircraft used for pilot training (not shown for purposes of clarity) and receives data from the aircraft's traffic alert and collision avoidance system (sometimes referred to herein as “TCAS”). The simulated radar system 100 is operable in at least two operation modes, including without limitation, an air-to-air mode and an air-to-ground mode. In the air-to-air operation mode, the simulated radar system 100 provides a simulated radar display using tactical symbology that is created from data received from the traffic alert and collision avoidance system. In the air-to-ground operation mode, the simulated radar system 100 provides a simulated terrain display of nearby terrain using appropriate symbology that is based on terrain map data stored on a data storage media. Because the simulated radar system 100 utilizes data from the aircraft's traffic alert and collision avoidance system and from a data storage media to produce displays simulating those of conventional aircraft radar systems without the bulky, space-consuming electronic components and radar antenna of such conventional radar systems, the simulated radar system 100 may be installed and used in the cockpit of training aircraft that do not have sufficient space available for a conventional radar system.

The simulated radar system 100 is, as illustrated in FIG. 2, communicatively connected to an aircraft's traffic alert and collision avoidance system when installed in an aircraft by communication link 102 for the receipt of messages therefrom. More particularly, communication link 102 is connected (i.e., in a tap-like manner) to a communication link of the aircraft's traffic alert and collision avoidance system that extends between a controller and display thereof. Through such connection and communication link 102, the simulated radar system 100 receives each message that is communicated between the TCAS controller and display via the communication link extending therebetween. Because such messages may include messages having data associated with aircraft representations for display by the TCAS display (sometimes referred to herein as “TCAS display messages”) as well as other messages and because the simulated radar system 100 utilizes the data present in such TCAS display messages to produce its simulated radar display in air-to-air operation mode, the simulated radar system 100 determines, as described below, which received messages constitute TCAS display messages and which received messages constitute other TCAS messages. The simulated radar system 100 disregards TCAS messages that do not constitute TCAS display messages.

The simulated radar system 100 is also communicatively connected, via communication link 104, to another aircraft system that is adapted to provide position data to the simulated radar system 100 corresponding to the position of the aircraft. Such other aircraft system may comprise, for example, a global position satellite system (“GPSS”) that continually determines and provides position data for the aircraft to the simulated radar system 100. The position data received from such other aircraft system via communication link 104 is utilized by the simulated radar system 100 when operating in air-to-ground mode to determine which terrain features of the terrain map data are within a display range selected by a pilot or other user of the simulated radar system 100. Such terrain features are displayed by the simulated radar system 100.

As illustrated in FIG. 2, the simulated radar system 100 comprises a controller 106, a display 108, a plurality of controls 110, and a data storage device 112 storing terrain map data. The controller 106 is connected, when installed in an aircraft, to communication links 102, 104 for the receipt, respectively, of TCAS messages and aircraft position data. The controller 106 is connected to the display 108 through communication link 114 for the communication of display data from the controller 106 to the display 108. Such display data may comprise data corresponding to other aircraft when the simulated radar system 100 is operating in air-to-air operation mode and data corresponding to terrain features when the simulated radar system 100 is operating in air-to-ground operation mode.

Generally, the display data corresponding to other aircraft includes data representative of each aircraft that is within a desired display range and may include, for example, data related to (a) the other aircraft's position relative to the aircraft in which the simulated radar system 100 is present (sometimes referred to herein as the “training aircraft”), (b) the other aircraft's heading (e.g., bearing), speed, altitude, rate of climb or descent, (c) the other aircraft's status as a “friend” or “foe”, and/or (d) other tactical information related to the other aircraft. The display data corresponding to other aircraft is typically in a form that enables the display 108 to represent the other aircraft using tactical symbology employed by conventional military radar systems. It should be noted, however, that the scope of the present invention encompasses display data corresponding to other aircraft that enables the display 108 to represent such other aircraft using non-tactical symbology or symbology utilized by the radar systems of commercial aircraft.

The display data corresponding to terrain features typically includes data representative of each terrain feature of the terrain map data that is within a desired display range of the training aircraft such that a pilot or radar operator may identify the terrain features when such data is displayed by display 108 in air-to-ground mode. Such display data is generally in a form that enables the display 108 to represent the terrain features using an appropriate symbology and may include data related to, for example, (a) the position and altitude of various mountains, hills, rivers, streams, and other landmarks, (b) the position of potential enemy targets, (c) the position of friendly installations, and/or (d) other information related to terrain features.

The display 108 is adapted to produce images representative of display data received from the controller 106 through communication link 114. Generally, the display 108 comprises a flat panel display that is operable to receive and produce an image from display data in raster form. It should be understood, however, that the scope of the present invention includes simulated radar systems 100 having other types of displays 108 or displays 108 that utilize other display technologies.

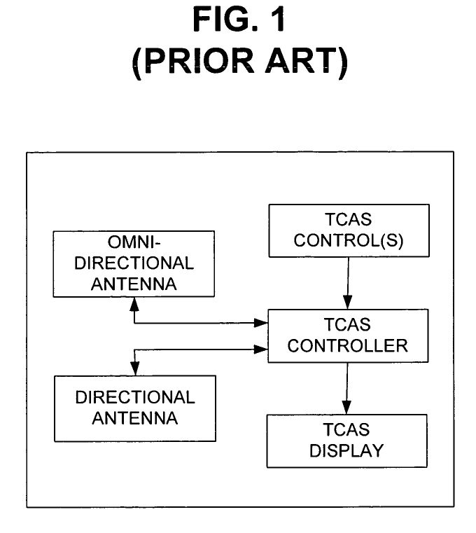

It should be noted that in an exemplary embodiment of the invention both the simulated radar system 100 as illustrated in FIG. 2 and a conventional TCAS as illustrated in FIG. 1 reside in the same training aircraft. Thus, the pilot or student pilot can view both the display 108 of the simulated radar system 100 as well as the conventional TCAS display. It should be noted that in some implementations the display 108 may serve two functions and may alternatively be used to display simulated radar data or TCAS data.

The controller 106 is also connected to the plurality of controls 110 by communication links 116 such that the controller 106 may determine or read the current settings of the controls 110. Generally, the controls 110 comprise input devices that enable a pilot or radar operator to provide inputs to the simulated radar system 100. One such control 110A comprises an operation mode selector that is used by a pilot or radar operator to select an operation mode for the simulated radar system 100. Control 110A is movable between a first position in which the air-to-air operation mode is selected and a second position in which the air-to-ground operation mode is selected. Another such control 110B comprises a range selector that is used by a pilot or radar operator to select a range or distance within which the simulated radar system 100 will display representations of and information related to other aircraft (i.e., if the simulated radar system 100 is in air-to-air mode) or to nearby terrain features (i.e., if the simulated radar system 100 is in air-to-ground mode). Control 110B is movable between a plurality of positions corresponding to respective display ranges. Exemplary ranges or distances might include 25 miles, 50 miles, or 100 miles. Generally, the controls 110 comprise switches that may be manually positioned by a pilot or radar operator. However, many other forms of controls 110 might be employed (including, without limitation, on-screen controls or buttons) within the scope of the present invention.

Preferably, the user interface effected by the combination of the controller 106, display 108 and controls 100 mimics or simulates the user interface of a specific radar system. For example, the display symbology, type and layout of controls, and other characteristics of a radar user interface typically vary among radar system products, as each manufacturer produces radar systems having characteristics unique to that manufacturer or product line. Indeed, many such products have a distinctive “look and feel” associated with the manufacturer or product line. Thus, the user interface effected by the combination of the controller 106, display 108 and controls 100 can simulate that of a specific product with which it is desired for the student pilot to become familiar.

The controller 106 is additionally connected to the data storage device 112 via communication link 118 for the communication of commands and other signals to the data storage device 112 requesting terrain map data and for the receipt of terrain map data stored on the data storage device 112. Generally, the data storage device 112 comprises an optical disk drive having a removable media storing terrain map data thereon that is representative of the terrain to be simulatively overflown during a training session using the simulated radar system 100. Thus, different removable media may be employed to enable training sessions that simulate the overflight of different terrain. The data storage device 112 may communicate terrain map data to the controller 106 in streaming video form or in non-streaming video form. Further, it should be noted that data storage device 112 may comprise any device adapted to store terrain map data, to receive requests for desired terrain map data from the controller 106, to retrieve such desired terrain map data, and to provide such desired terrain map data to the controller 106. Therefore, the data storage device 112 may comprise, for example and not limitation, flash memory, random access memory, read-only memory, programmable read-only memory, other electronic storage devices, magnetic disk drive(s), magneto-optical disk drive(s), other devices having removable or non-removable media, and/or other devices or combination(s) thereof.

The controller 106 generally comprises one or more microprocessor(s), memory, and one or more communication interfaces to receive TCAS messages from the aircraft's TCAS via communication link 102, to receive position data corresponding to the position of the aircraft via communication link 104, and to communicate commands, data, and/or signals with the display 108, controls 110, and data storage device 112 via respective communication links 114, 116, 118. The memory is configured with a plurality of software program instructions that are executable by the one or more microprocessor(s) to cause the simulated radar system 100 to operate in accordance with the methods described herein. The memory is also adapted to store intermediate and/or temporary data that may be generated during execution of the software program instructions and during operation of the simulated radar system 100. Such intermediate data includes target data corresponding to potential radar targets in air-to-air operation mode that is stored in an area of memory referred to herein as target data memory. Such intermediate data further includes display data for display on display 108 that is stored in a different area of memory referred to herein as display memory. Typically, the memory comprises flash memory and random access memory, but may include other forms of memory or other devices for storing data.

The software program instructions of the controller 106 are organized into a main program, a target data generation routine, a target display data generation routine, a terrain display data generation routine, and a display routine. The main program, when executed by a controller microprocessor, controls the overall operation of the simulated radar system 100 according to a method 300 of providing simulated air-to-air and/or air-to-ground radar for training pilots and/or radar operators. The target data generation routine is executed by a controller microprocessor when control 110A (e.g., the operation mode selector) is positioned in the position corresponding to the air-to-air operation mode. When executed by a controller microprocessor, the target data generation routine causes the simulated radar system 100 to operate in accordance with a target data generation method 400 that monitors TCAS messages for TCAS display messages, produces target data from information extracted from the TCAS display messages, and stores the target data in target data memory. The target display data generation routine is also executed by a controller microprocessor when control 110A is positioned in the position corresponding to the air-to-air operation mode. When executed, the target display data generation routine causes the simulated radar system 100 to operate according to a target display data generation method 500 that retrieves target data from target data memory, determines whether the retrieved target data is within a desired display range as indicated by the then current position of control 110B (e.g., the range selector), generates target display data for radar targets within such desired display range using tactical radar symbology appropriate for each radar target, and stores the generated target display data in display memory.

The terrain display data generation routine is executed by a controller microprocessor when control 110A (e.g., the operation mode selector) is positioned in the position corresponding to the air-to-ground operation mode. When executed by a controller microprocessor, the terrain display data generation routine causes the simulated radar system 100 to operate in accordance with a terrain display data generation method 600 that retrieves terrain map data from data storage device 112 that is within a desired display range (e.g., as indicated by the then current position of control 110B) of the aircraft's then current position, generates terrain display data for such retrieved terrain map data using symbology appropriate for the various terrain features, and stores the generated terrain display data in display memory.

The display routine is generally executed by a controller microprocessor on a continual basis regardless of whether control 110 is positioned in the position corresponding to the air-to-air operation mode or in the position corresponding to the air-to-ground operation mode. During execution, the display routine causes the simulated radar system 100 to operate according to a display method that retrieves display data from display memory and communicates the retrieved display data to the system's display 108 via communication link 114. One of ordinary skill in the art should be familiar with such display methods and, therefore, the display routine is not described herein in further detail.

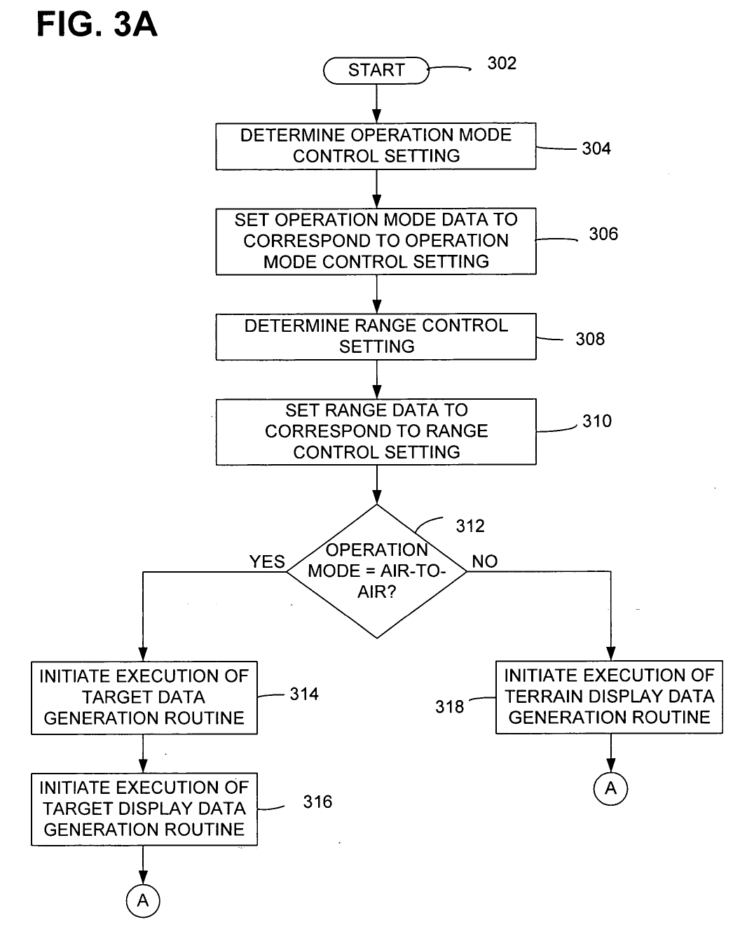

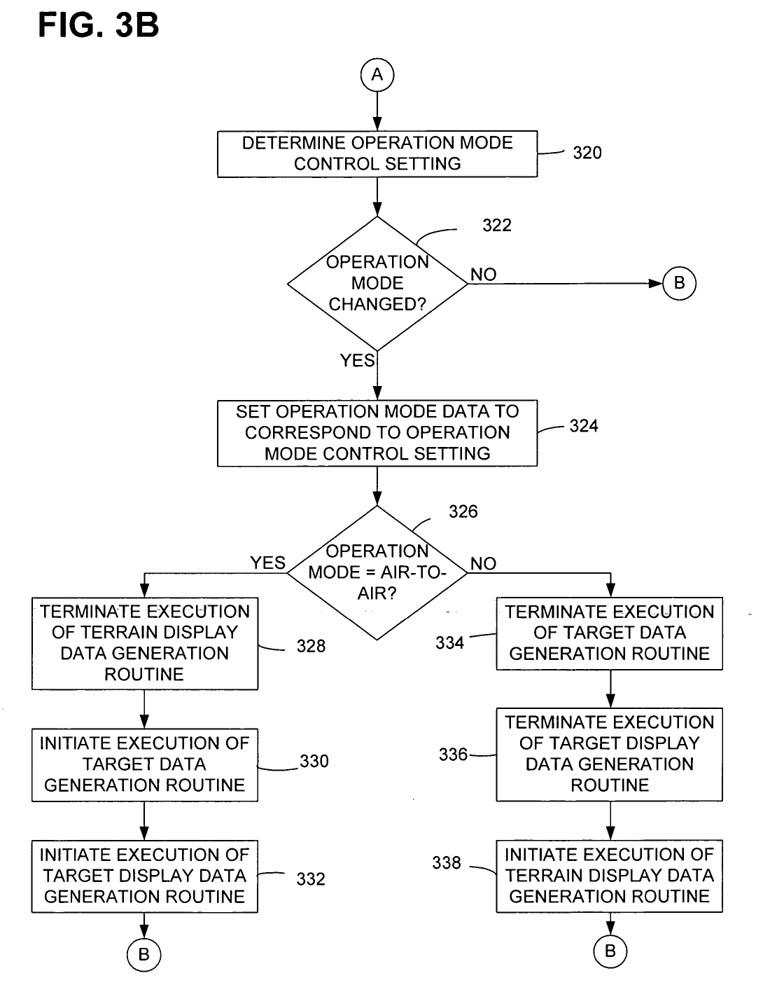

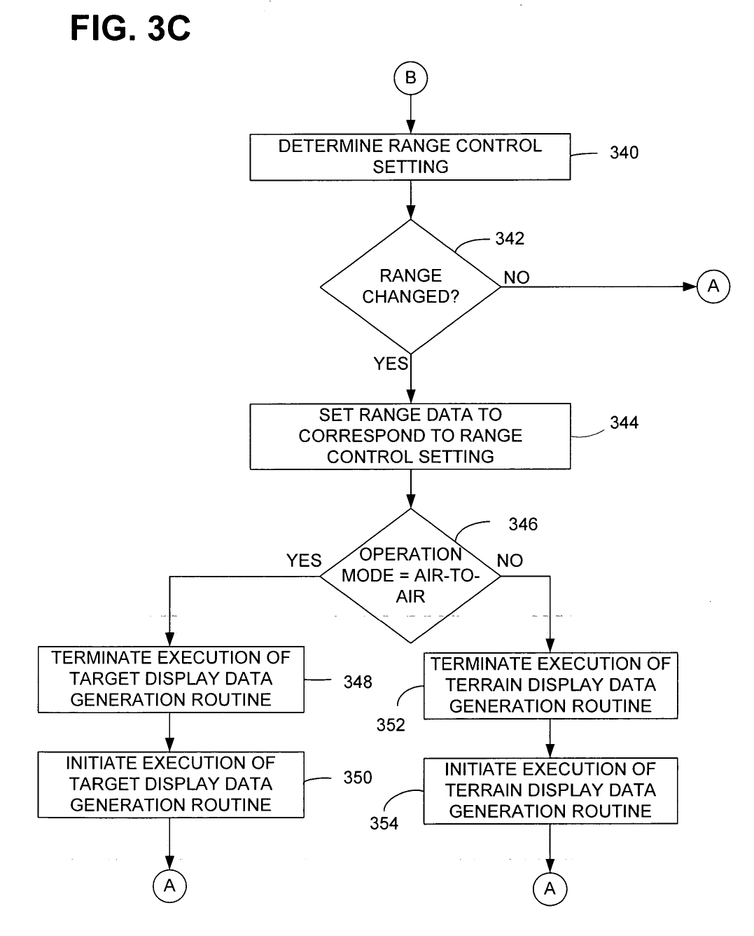

FIGS. 3A-3C together provide a flowchart representation, in accordance with the exemplary embodiment of the present invention, of a method 300 for providing simulated air-to-air and air-to-ground radar for training pilots and/or radar operators. After starting at step 302, method 300 advances to step 304 where the controller 106 determines the currently desired operation mode of the simulated radar system 100 by reading the position of control 110A (e.g., the operation mode selector). Then, at step 306, the controller 106 sets (e.g., establishes and stores) intermediate operation mode data in the controller's memory to correspond to the read position setting of control 110A. Proceeding to step 308 of method 300, the controller 106 determines the currently desired display range for target and/or terrain map data to be displayed via the simulated radar system 100 by reading the position of control 110B (e.g., the range selector). After reading the position of control 110B, the controller 106 sets (e.g., establishes and stores) intermediate range data in the controller's memory, at step 310, to correspond to the read position setting of control 110B.

At step 312 of method 300, the controller 106 ascertains whether the operation mode is set to air-to-air mode or air-to-ground mode by retrieving and analyzing the intermediate operation mode data stored in the controller's memory. If the operation mode is set to air-to-air mode, the controller 106 advances to step 314 where it initiates execution of the target data generation routine. Then, at step 316, the controller 106 initiates execution of the target display data generation routine. Upon such initiation, the controller 106 proceeds to step 320 of method 300 described below. If, at step 312, the controller 106 ascertains that the operation mode is set to air-to-ground mode, then the controller 106 initiates execution of the terrain display data generation routine at step 318 before moving to step 320 of method 300.

The controller 106 begins a loop of operation at step 320 by once again determining the currently desired operation mode of the simulated radar system 100 by reading the position of control 110A (e.g., the operation mode selector). Then, at step 322, the controller 106 decides whether the desired operation mode of the simulated radar system 100 has been changed by a pilot and/or radar operator since the last pass through the loop. The controller 106 generally makes such decision by comparing the position of control 110A read at step 320 with the intermediate operation mode data stored in the controller's memory. If the controller 106 decides that the position of control 110A corresponds to the intermediate operation mode data, then no change in operation mode has occurred since the last pass through the loop and the controller 106 advances to step 340 of method 300 described below. If the controller 106 decides that the position of control 110A does not correspond to the intermediate operation mode data, then at step 324 the controller 106 sets (e.g., establishes and stores) the intermediate operation mode data in the controller's memory to correspond to the position setting of control 110A read at step 320.

Continuing at step 326 of method 300, the controller 106 ascertains whether the operation mode is set to air-to-air mode or air-to-ground mode by retrieving and analyzing the intermediate operation mode data stored in the controller's memory. If the operation mode is set to air-to-air mode, the controller 106 advances to step 328 where it terminates execution of the terrain display data generation routine since the operation mode was formerly air-to-ground mode and since the terrain display data generation routine would be executing in such mode. Then, the controller 106 initiates execution of the target data generation routine at step 330 and initiates execution of the target display data generation routine at step 332. After initiating these routines, the controller 106 moves ahead to operate in accordance with step 340 described below.

If, at step 326, the controller 106 ascertains that the operation mode is set to air-to-ground mode, the controller 106 proceeds to step 334 of method 300 where it terminates execution of the target data generation routine and subsequently to step 336 where it terminates execution of the target display data generation routine. The terminations of these routines are made since the operation mode was formerly air-to-air mode and since the target data generation routine and target display data generation routine would be executing in such mode. Then, the controller 106 moves to step 338 where it initiates execution of the terrain display data generation routine before advancing to step 340 described below.

At step 340 of method 300, the controller 106 determines the currently desired display range for target and/or terrain map data to be displayed via the simulated radar system 100 by reading the position of control 110B (e.g., the range selector). After reading the position of control 110B, the controller 106 decides at step 342 whether the desired display range of the simulated radar system 100 has been changed by a pilot and/or radar operator since the last pass through the loop. The controller 106 generally makes such decision by comparing the position of control 110B read at step 340 with the intermediate range data stored in the controller's memory. If the controller 106 decides that the position of control 110B corresponds to the intermediate range data, then no change in operation mode has occurred since the last pass through the loop and the controller 106 loops back to step 320 of method 300 described above. If the controller 106 decides that the position of control 110B does not correspond to the intermediate range data, then at step 344 the controller 106 sets (e.g., establishes and stores) the intermediate range data in the controller's memory to correspond to the position setting of control 110B read at step 340.

After setting the intermediate range data, the controller 106 ascertains at step 346 whether the operation mode is set to air-to-air mode or air-to-ground mode by retrieving and analyzing the intermediate operation mode data stored in the controller's memory. If the operation mode is set to air-to-air mode, the controller 106 advances to step 348 where it terminates execution of the target display data generation routine. Then, at step 350, the controller 106 initiates execution of the target display data generation routine. By first terminating execution of the target display generation routine and then re-initiating its execution, the controller 106 causes the display of radar target data to be reset for the currently desired display range. Once execution of the target display data generation routine is re-initiated, the controller 106 loops back to operate according to step 320 of method 300.

If, at step 346, the controller 106 ascertains that the operation mode is set to air-to-ground mode, the controller 106 proceeds to step 352 where it terminates execution of the terrain display data generation routine. The controller 106 then, at step 354, re-initiates execution of the terrain display data generation routine. Through the termination and re-initiation of the terrain display data generation routine, the controller 106 causes the display of terrain map data to be reset for the currently desired display range. After re-initiating execution of the terrain display data generation routine, the controller 106 returns to step 320 of method 300 where it once again determines the currently desired operation mode of the simulated radar system 100.

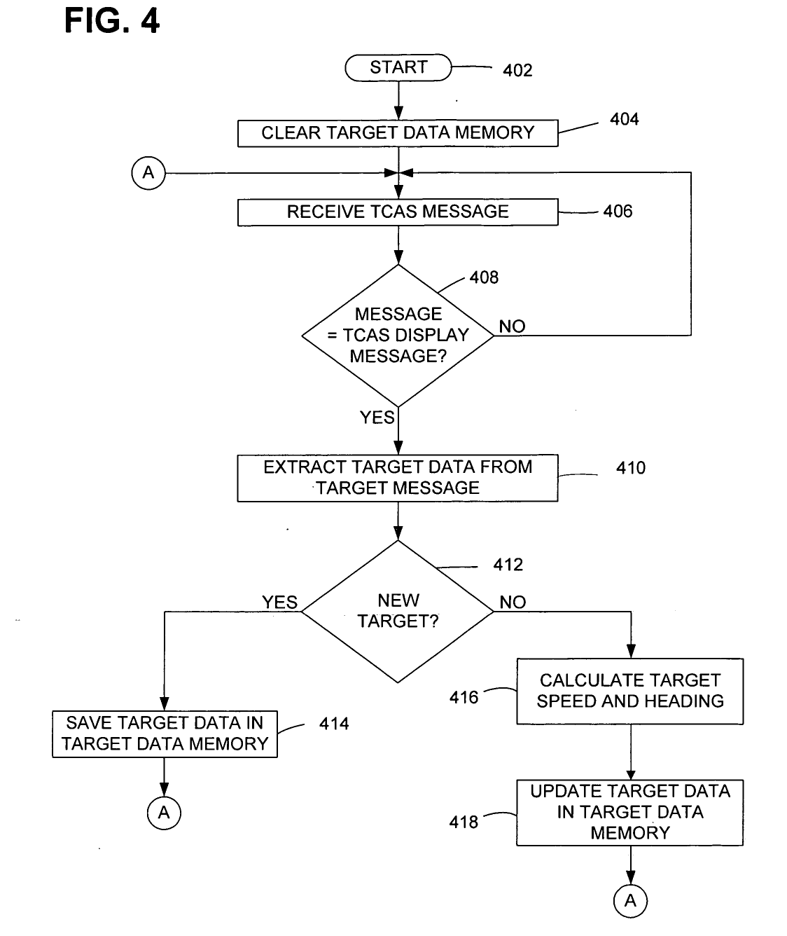

FIG. 4 is a flowchart representation of a target data generation method 400, in accordance with the exemplary embodiment of the present invention, for producing and storing target data respectively associated with aircraft detected by the training aircraft's TCAS. The target data is produced from data collected from intercepted TCAS display messages and is stored in the controller's target data memory. After starting at step 402, the method 400 advances to step 404 where the controller 106 clears the target data memory. Then, at step 406, the controller 106 receives a TCAS message from the aircraft's TCAS via communication link 102. Generally, the TCAS messages so received constitute TCAS display messages having data respectively associated with aircraft detected by the aircraft's TCAS, but may conceivably constitute other types of TCAS messages. Therefore, at step 408, the controller 106 determines whether the received TCAS message constitutes a TCAS display message. If not, the controller 106 loops back to step 406 to receive another TCAS message.

If, at step 408, the controller 106 determines that the received TCAS message is a TCAS display message, the controller 106 advances to step 410 of method 400 where it extracts data from the TCAS display message. Such data (sometimes referred to herein as “target data”) includes, for example and not limitation, data defining the identity, range, bearing, and altitude of the aircraft associated with the received TCAS display message. Proceeding to step 412, the controller 106 ascertains whether the aircraft associated with the received TCAS display message (sometimes referred to herein as a “target”) constitutes a new target for the simulated radar system 100. The controller 106 does so by comparing the identity data for the target associated with the received TCAS display message to the identity data associated with targets already present in the controller's target data memory. If the identity data for the target associated with the received TCAS display message is not present in the target data memory, then the target is a new one and the controller 106 moves to step 414 of method 400 where it saves the target data for the target in the controller's target data memory. Then, the controller 106 returns to step 406 to receive another TCAS message via communication link 102.

If the controller 106 ascertained, at step 412, that the aircraft associated with the received TCAS display message is not a new target for the simulated radar system 100, then the controller 106 advances to step 416 of method 400 where it calculates target speed and heading by comparing current range and bearing data with previous values. The controller 106 then advances to step 418 of method 400 updates the already present target data for the target in the controller's target data memory with the target data newly received in the TCAS display message. After updating the target data, the controller 106 loops back to step 406 to receive another TCAS message from the aircraft's TCAS through communication link 102.

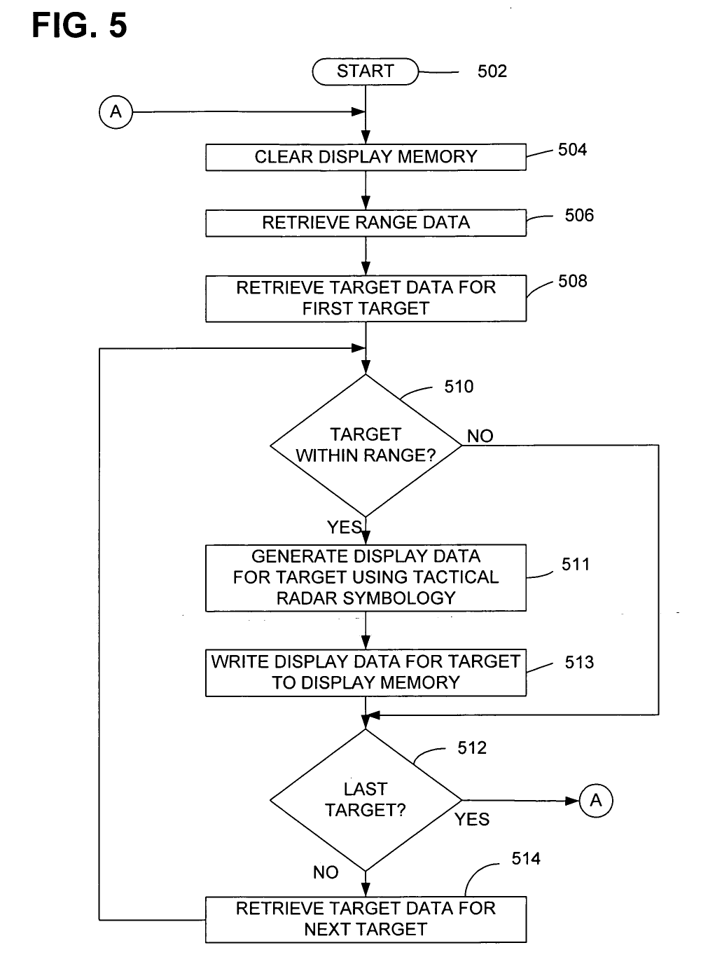

FIG. 5 is a flowchart representation of a target display data generation method 500, in accordance with the exemplary embodiment of the present invention, for generating target display data respectively associated with aircraft detected by the training aircraft's TCAS. After starting at step 502, the method 500 advances to step 504 where the controller 106 clears the display memory. Then, at step 506, the controller 106 retrieves the intermediate range data stored in the controller's memory. The controller 106 next retrieves target data associated with the first target in the target data memory at step 508.

Continuing at step 510, the controller 106 determines whether the target associated with the retrieved target data is within the desired display range for the simulated radar system 100 corresponding to the intermediate range data retrieved at step 506. The controller 106 does so by using the retrieved target data to calculate the range, or distance, of the target from the training aircraft and by comparing the calculated range, or distance, to the range corresponding to the intermediate range data. If the controller 106 determines that the target is not within the desired display range, the controller 106 branches to step 512 of method 500 described below. If, alternatively, the controller 106 determines at step 510 that the target is within the desired display range, then at step 511 controller 106 generates display data for the target (sometimes referred to herein as “target display data”) using the target data for the target and employing tactical radar symbology. Thus, based on the identity data found in the target data for the target, the controller 106 may produce target display data that includes an identification of the radar target as a “friend” or “foe”. Then, at step 513, the controller 106 writes or communicates the generated target display data to the controller's display memory.

At step 512, the controller 106 decides whether it has retrieved target data for the last target having target data stored in the target data memory. If so, the controller 106 returns to step 504 to once again clear the display memory (i.e., which is necessary as existing targets may move in and out of the desired display range and new targets may move into the desired display range). If not, the controller 106 retrieves the target data associated with the next target having target data stored in the target data memory at step 514. Then, the controller 106 continues operation according to method 500 by looping back to step 510 to determine whether the next target is within the desired display range for the simulated radar system 100.

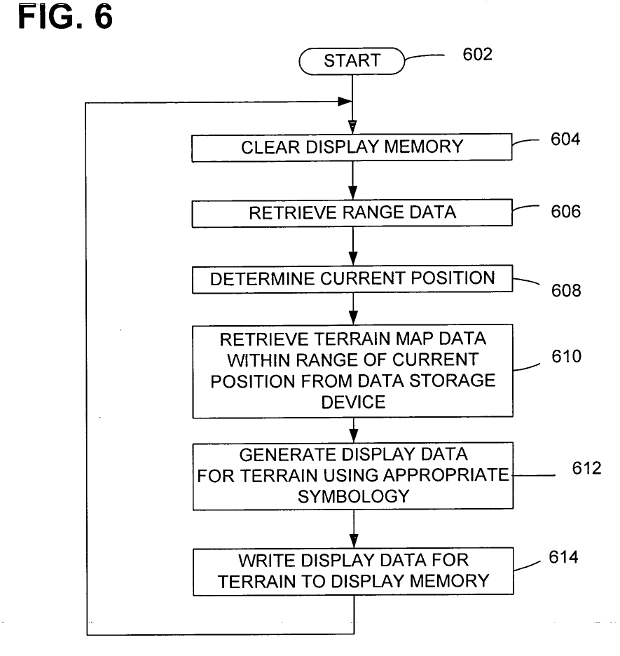

FIG. 6 is a flowchart representation of a terrain display data generation method 600, according to the exemplary embodiment of the present invention, for generating terrain display data associated with the terrain being overflown or near the then current location of the training aircraft. After starting at step 602, the method 600 advances to step 604 where the controller 106 clears the display memory. Then, at step 606, the controller 106 retrieves the intermediate range data stored in the controller's memory. The controller 106 next determines the current position of the training aircraft at step 608. To do so, the controller 106 generally utilizes the position data for the training aircraft received from another aircraft system via communication link 104.

Next, at step 610, the controller 106 retrieves terrain map data from data storage device 112 via communication link 118 that is within the range, or distance, identified by the intermediate range data from the training aircraft's current position. The controller 106, at step 612, subsequently generates display data for the terrain using the retrieved terrain map data and symbology that is appropriate for the various features of the terrain. Then, at step 614, the controller 106 writes or stores the generated display data to the controller's display memory. After storing the display data, the controller 106 loops back to step 604 of method 600 to again clear the display memory and regenerate display data since the current position of the training aircraft will be different.

Whereas this invention has been described in detail with particular reference to an exemplary embodiment and variations thereof, it is understood that other variations and modifications can be effected within the scope and spirit of the invention, as described herein before and as defined in the appended claims.

What is claimed is:

1. A system for simulating aircraft radar, said system comprising:
a simulated radar display device for displaying simulated radar data; and
a controller communicatively connected to said display device and adapted to generate said simulated radar data at least in part from electronic messages obtained from a traffic alert and collision avoidance system (TCAS).

2. The system of claim 1, wherein said system further comprises a communication link adapted to communicatively connect between said controller and said traffic alert and collision avoidance system and to communicate said electronic messages from said TCAS to said controller.

3. The system of claim 2, wherein said communication link is further adapted to communicatively connect to a communication link of said traffic alert and collision avoidance system present between a controller and a display of said TCAS.

4. The system of claim 1, wherein said TCAS includes a TCAS display device.

5. The system of claim 1, wherein said electronic messages include data formatted for presentation on said display of said traffic alert and collision avoidance system.

6. The system of claim 1, wherein said electronic messages include data representative of positions of aircraft.

7. The system of claim 1, wherein said simulated radar data utilizes tactical military symbology to represent aircraft.

8. The system of claim 1, wherein said system further comprises a data storage device communicatively connected to said controller and including a terrain map data, wherein said simulated radar display data comprises first simulated radar display data, and wherein said controller is further adapted to generate second simulated radar display data at least in part from terrain map data of said data storage device.

9. The system of claim 1, wherein the controller comprises at least one user input of a user interface, the displaying of the simulated radar data on the simulated radar display device defines a user output of a user interface, and the user interface user inputs and user outputs emulate a user interface of a predetermined commercially available radar product.

10. A method for simulating aircraft radar in an aircraft having an aircraft traffic alert and collision avoidance system (TCAS) but not having radar, the method comprising the steps of:
reading data communicated to a TCAS display device;
generating simulated radar display data based at least in part on the data read; and
displaying the simulated radar display data on a simulated radar display device.

11. The method of claim 10, wherein the method further comprises a step of extracting data related to the position of other aircraft from the data read, and wherein the simulated radar display data includes data representative of the position of the other aircraft.

12. The method of claim 10, wherein the step of generating includes generating the simulated radar display data using tactical military symbology.

13. The method of claim 10, wherein the data read include display data intended for presentation on the display of the aircraft traffic alert and collision avoidance system.

14. The method of claim 10, wherein the method further comprises the steps of retrieving terrain map data from a data storage device, and generating simulated radar data based at least in part on the retrieved terrain map data.

15. The method of claim 10, wherein the step of extracting data further includes extracting data uniquely identifying other aircraft, and wherein said simulated radar data includes data identifying other aircraft as friend or foe.

16. A system for simulating aircraft radar, said system comprising:
a simulated radar display device configured to receive and display simulated radar data; and
a controller communicatively connected to said simulated radar display device and adapted to operate in an air-to-air operation mode and in an air-to-ground operation mode, said controller being further adapted to produce said simulated radar data from data obtained from a traffic alert and collision avoidance system (TCAS) when said controller operates is said air-to-air operation mode;
wherein said simulated radar data includes data representative of other aircraft when said controller operates in said air-to-air operation mode and data representative of nearby terrain when said controller operates in said air-to-ground operation mode.

17. The system of claim 16, wherein said controller is switchable by an operator between said air-to-air operation mode and said air-to-ground operation mode.

18. The system of claim 16, wherein said data obtained from said TCAS comprises data intended for display by said TCAS.

19. The system of claim 16, wherein said system further comprises a data storage device communicatively connected to said controller and storing terrain map data, and wherein said controller is further adapted to produce said simulated radar data from terrain map data when said controller operates in said air-to-ground operation mode.

20. The system of claim 16, wherein the controller comprises at least one user input of a user interface, the display of the simulated radar data on the simulated radar display device defines a user output of a user interface, and the user interface user inputs and user outputs emulate a user interface of a predetermined commercially available radar product.
